(19) United States
(12) Patent Application Publication
(10) Pub. No.: US 2008/0222531 A1
(43) Pub. Date: Sep. 11, 2008

(54) CONVERSATION TRACKING AND NOTIFICATION

(75) Inventors: Michael Davidson, Seattle, WA (US); Mark F. Budos, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/045,630

(22) Filed: Mar. 10, 2008

Related U.S. Application Data
(60) Provisional application No. 60/894,157, filed on Mar. 9, 2007.

(51) Int. Cl. G06F 15/177

(52) U.S. Cl. 715/736

(57) ABSTRACT

A facility for tracking actions performed by users on content. The facility monitors items of content that are being tracked for a user, and detects actions performed by other users pertaining to the tracked content. Actions may be any activity performed by a user with respect to an item of content, such as replying to content, rating an item of content, or editing content. The facility collects tracking statistics and provides the tracking statistics for on-site presentation to users. Users thereby stay engaged in conversations around content because they can quickly determine whether additions have been made to the conversation since they last participated. The users may use the tracking statistics to directly navigate to new content. The facility may allow a user to characterize a relationship with one more other individuals and track actions performed by the characterized individuals.

### CROSS-REFERENCE TO RELATED APPLICATION

This application claims the benefit of U.S. Provisional Patent Application No. 60/894,157 (Attorney Docket No. 59467-8001.US00) entitled “INLINE CONVERSATION TRACKING AND NOTIFICATION,” and filed on Mar. 9, 2007, which is hereby incorporated by reference.

### BACKGROUND

The continued growth of the Internet has resulted in an array of communication mechanisms for exchanging information. For example, information is exchanged using email, discussion boards, blogs, RSS (Really Simple Syndication) feeds, social networking websites, news publication websites, trip planning websites, customer review websites, photo sharing websites, gaming websites, etc. Many of the technologies that enable users to exchange information also enable multiple users to participate in the exchange. When information is exchanged on a discussion board, for example, users may respond to questions posted by other users. When information is exchanged on a blog (i.e., a web-based journal consisting of periodic articles or postings), users may visit the blog and add comments to the blog.

Websites, such as blogs and discussion boards, which allow users to leave comments and carry on threaded asynchronous conversations generally suffer from one glaring problem: users have a difficult time finding their old comments and more importantly knowing when someone else has responded to them. Generally, it is up to the user to manually check in on each discussion they are involved in and try to figure out which replies are “new” to them.

Although users enjoy certain benefits from the ever increasing exchange of information, these benefits are generally short lived. The inviting nature of the Internet has resulted in an information overflow-information is exchanged between users at a rate that exceeds the users' ability to effectively exchange information (if at all). To manage this information overflow, some users have limited the sources or ways in which they exchange information. However, limiting a user's exchange of information reduces the benefits enjoyed by the user, as well as other users with whom the user would have exchanged information had the user not limited the sources or ways in which the user exchanged information.

### BRIEF DESCRIPTION OF THE DRAWINGS

FIG. 1 is a data flow diagram that illustrates various components or services that are part of or interact with a facility.

FIG. 2 is a block diagram showing some of the components typically incorporated in at least some of the computer systems and other devices on which the facility executes.

FIG. 3 is a flow chart of processing performed by the facility to initiate tracking of content.

FIG. 4 is a flow chart of actions performed by the facility when an action is detected on tracked content.

FIGS. 5 is a representative record containing tracking information associated with an item of tracked content.

FIG. 6 is a screenshot of a user interface depicting a user publishing an article.

FIG. 7 is a screenshot of a user interface depicting a conversation associated with an item of user-contributed content.

FIGS. 8A, 8B, 8C, and 8D are screenshots of a user interface depicting a user's navigation of an item of content tracked by the facility.

FIG. 9 is a flow chart of actions performed by the facility to generate numerical indicators indicating the number of actions performed on tracked items of content.

FIG. 10 is a screenshot of a user interface depicting a friends screen.

### DETAILED DESCRIPTION

A software and/or hardware facility (“the facility”) for tracking actions performed by users on content is described. The facility monitors items of content that are being tracked for a user, and detects actions performed by other users pertaining to the tracked content. Actions may be any activity performed by a user with respect to an item of content, such as replying to content (e.g., adding a comment to a blog post), rating an item of content, or editing content. Tracked content may be content that is contributed by the user (“user-contributed content”) or third-party content (“third-party” or “other” content) that a user has explicitly or implicitly indicated he/she is interested in tracking. The facility collects tracking statistics and provides the tracking statistics for on-site presentation to users. The users may use the tracking statistics to directly navigate to new content. Users are therefore free to start and participate in conversations without ever having to worry about the status of the conversations, as they are automatically notified on-site when new actions are performed that are associated with an item of content that is being tracked.

In some embodiments, the facility allows a user to characterize a relationship with one more other individuals, such as friends, family, or colleagues. The facility may then track actions performed by the designated individuals or groups of individuals. For example, the facility may notify the user when a friend posts a comment on a blog, thereby alerting the user to a potentially interesting item of content. Tracking conversations and actions taken by friends, family, or colleagues results in the spontaneous discovery of new content based on the actions of a trusted set of people.

In some embodiments, search capability is provided that enables users to search for and select content to be tracked. For example, in response to receiving a request for information about wedding planning in Seattle, a search may identify user-contributed content as well as third-party content (e.g., content from a third-party website such as theknot.com). When an item of third-party content is tracked, the user is notified on-site that an action has been performed with respect to the item of content. In some embodiments, third-party content is explicitly selected by the user (e.g., a user request to track a specific blog article). While in other embodiments, third-party content is implicitly selected by the user (e.g., a user request to track information on a specific topic).

In some embodiments, the facility tracks specific types of performed actions. For example, when a user replies to a blog post, the facility may track only direct replies to the user's reply. As another example, the facility may track any content that is edited by a friend of the user.

By monitoring information exchanged in some or all of the ways identified herein, the facility enables users to effectively manage their exchange of information without limiting the sources or ways in which they exchanged information.

The following description provides specific details for a thorough understanding of, and enabling description for, various embodiments of the facility. One skilled in the art will understand that the facility may be practiced without many of these details. In some instances, well-known structures and functions have not been shown or described in detail to avoid unnecessarily obscuring the description of the embodiments of the facility. It is intended that the terminology used in the description presented below be interpreted in its broadest reasonable manner, even though it is being used in conjunction with a detailed description of certain embodiments of the facility. Although certain terms may be emphasized below, any terminology intended to be interpreted in any restricted manner will be overtly and specifically defined as such in this Detailed Description section.

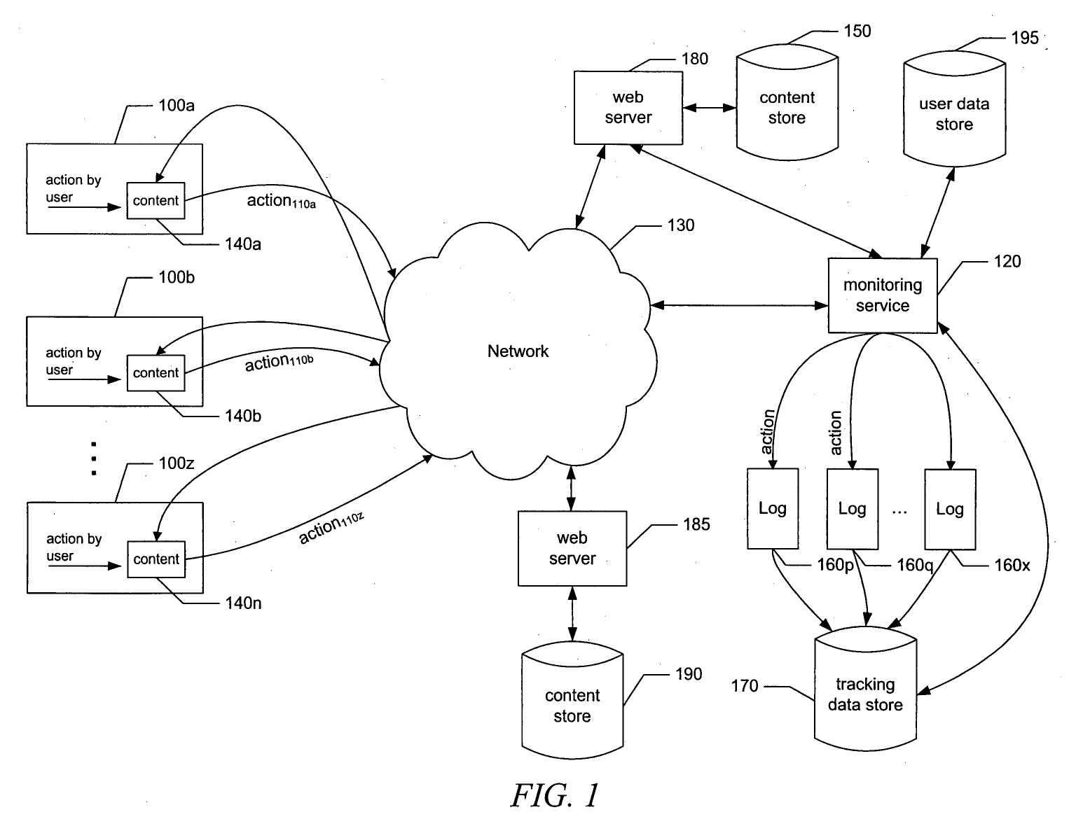

FIG. 1 is a data flow diagram that illustrates various components or services that are part of or interact with the facility. One or more users operate computer systems 100a, 100b, . . . 100z to view various items of content 140a, 140b, . . . 140n. Computer systems 100a, 100b, . . . 100z may be personal computers, terminals, mobile devices, workstations, or any other device that is capable of displaying content to a user. Content may be delivered to the computer systems by a web server 180 that retrieves the content from a content store 150. Content may also be delivered to the computer systems by a third-party web server 185 or other computing system that retrieves the content from a content store 190. The content is delivered to the computers via a public or private network 130, such as the Internet or a local area network.

Users of the computer systems 100a, 100b, . . . , 100z generate, review, share, edit, and/or otherwise exchange content 140a, 140b, . . . 140n with other users. Conversations are thereby created around various items of content. In order to enable the tracking feature, the facility has access to a user data store 195 containing user identifiers that allows the facility to associate actions performed by a user with respect to an item of content. Users that desire to track actions on their own or other content therefore register with the facility. When a user registers with the facility, a record associated with the user is created and stored in the user data store 195. The record assigns a unique identifier to the user for purposes of linking the user with content that the user desires to track. To enable tracking of content, the facility initially receives an indication of the item of content that is to be tracked by a user.

The facility tracks actions performed with respect to the items of tracked content. Each action is the result of a user performing an act with respect to an item of content. For example, the facility may detect when a user adds a comment to content, (e.g., a directly reply or a response to a blog post), edits existing content, rates content, views content, or otherwise performs any other action with respect to content. When an action 110a, 110b, . . . 110z is performed, a monitoring service 120 receives an indication of the performed action. The monitoring service may be notified of a performed action by web server 180, by third-party web server 185, or by any other computing system. The web server or third party web server may transmit messages to the monitoring service that includes information about actions performed with respect to an item of content. Alternatively, the monitoring service may monitor browser requests and responses transmitted between computers and a web server in order to ascertain the actions that are occurring with respect to items of content.

When an indication of a performed action is received or otherwise detected by the monitoring service 120, the monitoring service determines whether the action relates to an item of content being tracked for one or more users (“tracked content”). If the action pertains to an item of content being tracked, the monitoring system stores the indication of the performed action in a log 160p, 160q, . . . , 160x for subsequent processing. On a periodic basis, the logs are processed by the facility and the performed actions reflected in each log are aggregated and stored in a tracking data store 170. The monitoring service utilizes the information in the tracking data store to calculate tracking statistics and provides the tracking statistics to a webserver or other application for on-site presentation to a user in the manner described herein.

While various embodiments are described in terms of the environment described above, those skilled in the art will appreciate that the facility may be implemented in a variety of other environments including a distributed computer system, as well as various other combinations of computer systems or similar devices connected in various ways. In various embodiments, one or more of the functions described herein may be implemented as services to the facility.

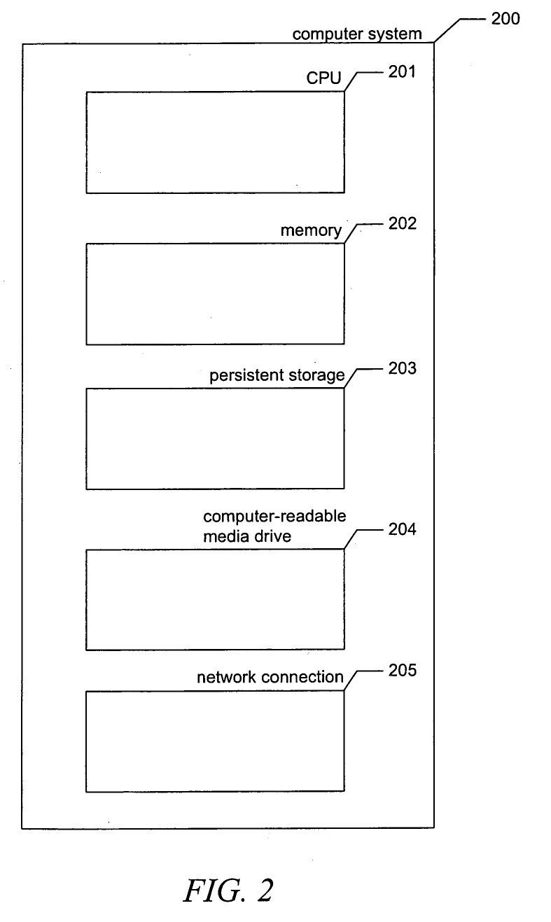

FIG. 2 is a block diagram showing components typically incorporated in at least some of the computer systems on which the facility executes. Each computer system 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection component 205 for connecting the computer system to other computer systems, such as via the Internet.

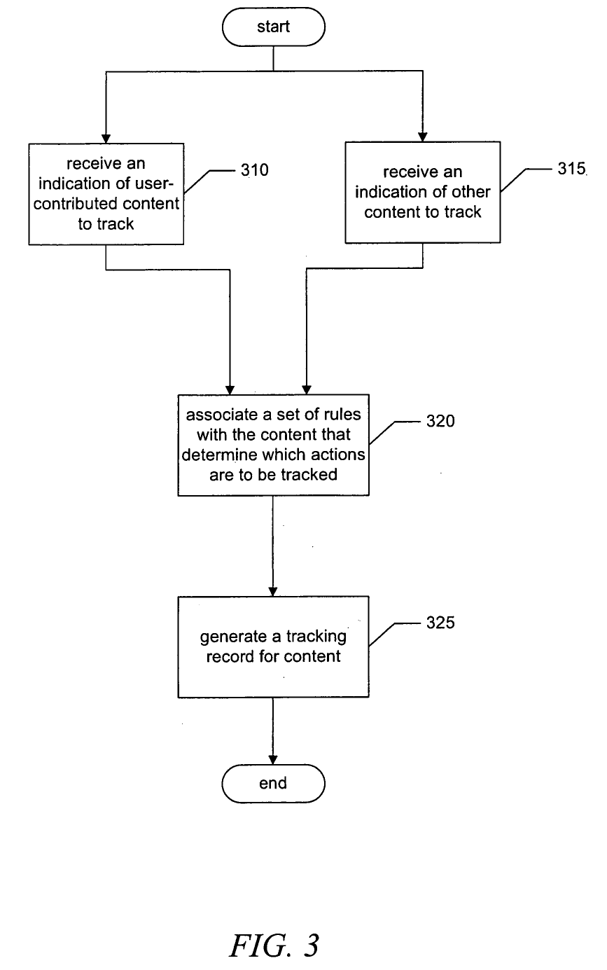

FIG. 3 is a flow chart of processing performed by the facility to initiate tracking of content. To enable tracking of content, the facility initially receives an indication of the content that is to be tracked. Two types of content may be tracked by the facility: user-contributed content or other content. At block 310, the facility receives an indication that a user has contributed content and desires to track the content (i.e., monitor the content for actions performed with respect to that item of content). For example, user-contributed content may be an article posted by the user to a website. As another example, the user may contribute a comment on existing content and desire to track actions performed with respect to the comment. When the user publishes an article to a website, the facility detects the publication of the article and correlates the published article with the user that contributed the article. Tracking may be automatically initiated for any content that is contributed by a user that registers with the facility, or tracking may be selectively initiated by the user for content that the user contributes. A new record is created in the tracking data store 170 to initiate the tracking of actions performed with respect to the indicated content.

At block 315, the facility receives an explicit or implicit indication to track other content (i.e., monitor pre-existing content for actions performed with respect to that content). For example, the facility may enable the user to track a conversation on a discussion board or a blog without participating in the conversation. When content is tracked in this manner, the user is notified of any actions that are performed with respect to the other content (e.g., when comments are posted to the discussion board conversation following the user's request to track the conversation). That is, a user can request to track a particular item of content without necessarily contributing content. As another example, a user can implicitly request to track a blog (or a number of websites) for posts about a particular topic (e.g., canine hygiene). As still another example, a user can request to track a comment on a blog.

At block 320, the facility associates a set of rules with the indicated content. The set of rules are configurable by a user or by a facility operator and determine which actions are to be tracked with respect to that content. The various rules may include:
Default tracking based on the type, action, and/or user associated with the indicated content. By default, for example, the facility may track all actions taken by all users with respect to indicated content.
User-specified tracking for indicated content. For example, a settings page may be displayed to the user that allows the user to specify how the indicated content will be tracked by the facility. A user may specify, for example, to only track direct replies to content or to only track replies received from another user that is within a specified list of users.
User-specified tracking for all content. For example, a user can specify that the facility track comments posted by friends of the user regardless of whether the comment is posted to content contributed by the user. As another example, a user can configure the facility to track direct replies to the user's blog post and indirect replies posted by a friend of the user.
   It will be appreciated by those skilled in the art that there are a variety of possible combinations of tracking rules, and that tracking rules may or may not be applied uniformly to user-contributed content and/or other content. For example, a user may establish tracking preferences based on any combination of the type of action, content, or user associated with the indicated content.

At block 325, the facility creates a new record in the tracking data store 170 that is associated with the indicated content. The record contains an indication of the set of rules that are associated with the content, as well as other rules that may be specified by the user or by the facility operator. For example, a user may specify how the tracking statistics are subsequently displayed to the user. The record may be represented, for example, by a table or database entry in the tracking data store. As will be discussed herein, the record is used by the facility to track actions performed with respect to the indicated content (e.g., comments posted to the content). By aggregating actions across content being tracked for the user, tracking statistics may be presented to the user. In some embodiments, tracking statistics are compiled as actions are detected, so that the user is presented on-site with near real-time data.

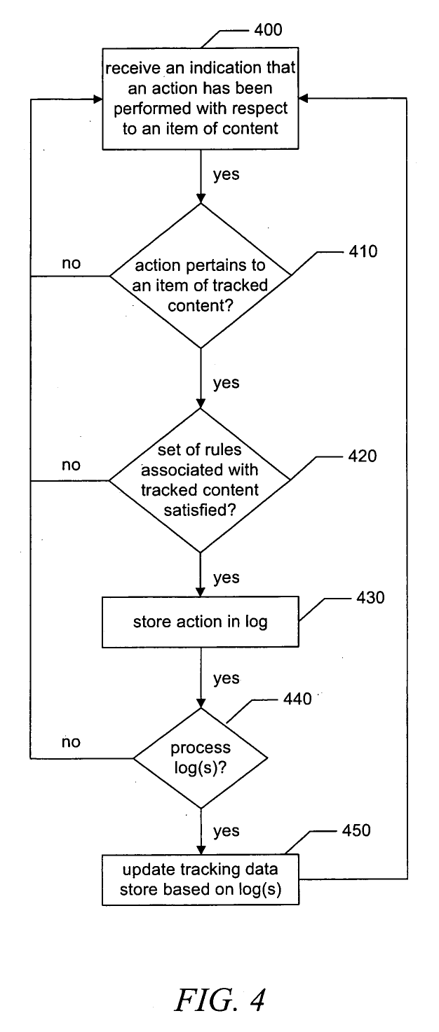

FIG. 4 is a flow chart of a process performed by the facility when an action is detected on tracked content. At block 400, the facility receives an indication that an action has been performed with respect to an item of content. At block 410, the facility determines whether the performed action pertains to an item of tracked content. If the action pertains to an item of tracked content, at a block 420, the facility applies the set of rules associated with the item of tracked content to determine whether the performed action satisfies the set of rules and therefore should be tracked. If the set of rules are satisfied, at a block 430, the facility stores the action in a log for processing. In some embodiments, the facility includes one or more logs 160p, 160q, . . . 160x that store actions performed with respect an item of tracked content. Typically, actions performed with respect to the same item of tracked content are stored in the same log 160p, 160q, . . . 160x. By storing actions performed with respect to the same item of tracked content in the same log, the facility can process actions in the order that they are performed. The facility can also process actions at a subsequent time from when the actions are received in order to manage the administrative overhead associated with the updating of the tracking data store. Being able to delay processing may be advantageous when the facility is scaled to manage the tracking of a large number of items of content.

At a block 440, the facility determines whether one or more logs should be processed. Logs may be processed on a sporadic basis, on a periodic basis, when a threshold number of log entries is reached, during periods of low activity, etc. If one or more logs are to be processed, at block 450 the tracking data store 170 is updated by the facility based on the performed actions stored in the processed log or logs.

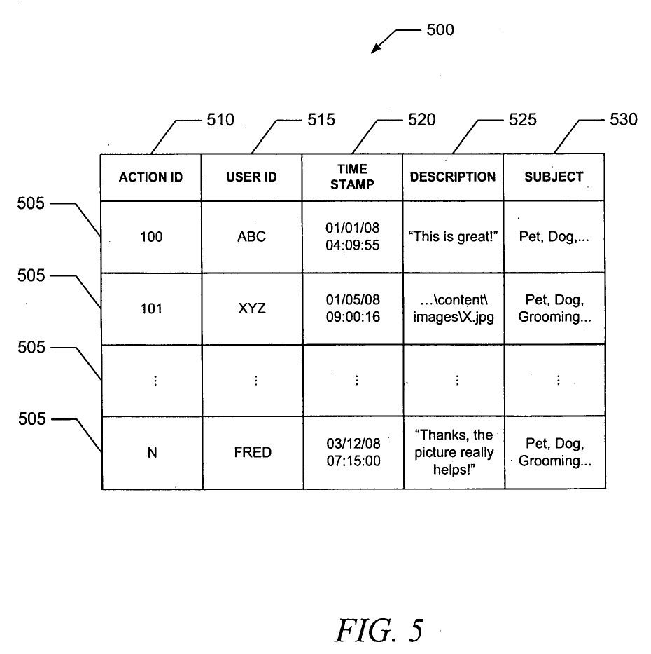

FIG. 5 is a representative record 500 depicting the tracking information associated with one item of tracked content that is stored by the facility in the tracking data store 170. Record 500 includes one or more entries 505, each representing an action performed with respect to the item of content that is associated with the record. Each action entry 505 is divided into fields which contain information reflecting the action taken with respect to the item of content. For example, an action ID field 510 is used as a unique identifier for each action. A user ID field 515 is provided to identify a user who performed the action. A time and/or date stamp field 520 is provided to identify the time and/or date when the action was performed. By comparing the last time the user visited the content with the time an action is performed, the facility can determine whether the action is new to the user. A description field 525 is provided to store a description of the action. For example, if the action corresponds to a comment, the text of the comment or a link to the content of the comment may be stored in the description field. A subject field 530 is also provided to categorize or tag the item of content. In some embodiments, the subject field may default to a subject associated with the content by the author of the content. In some embodiments, the facility enables the user performing the action to indicate the subject or subjects to which the action pertains. In some embodiments, the facility automatically determines the subject by analyzing the content or the performed action. It will be appreciated that one or more of the fields depicted in record 500 may be omitted, or one or more fields may be added, depending on the tracking statistics and functionality that is to be provided by the facility.

It will be appreciated that rather than having each record 500 associated with a single item of content, a table may be constructed wherein each action entry also has a file identifying the item of content associated with that action entry. A single data table may then be used to reflect all items of content being tracked.

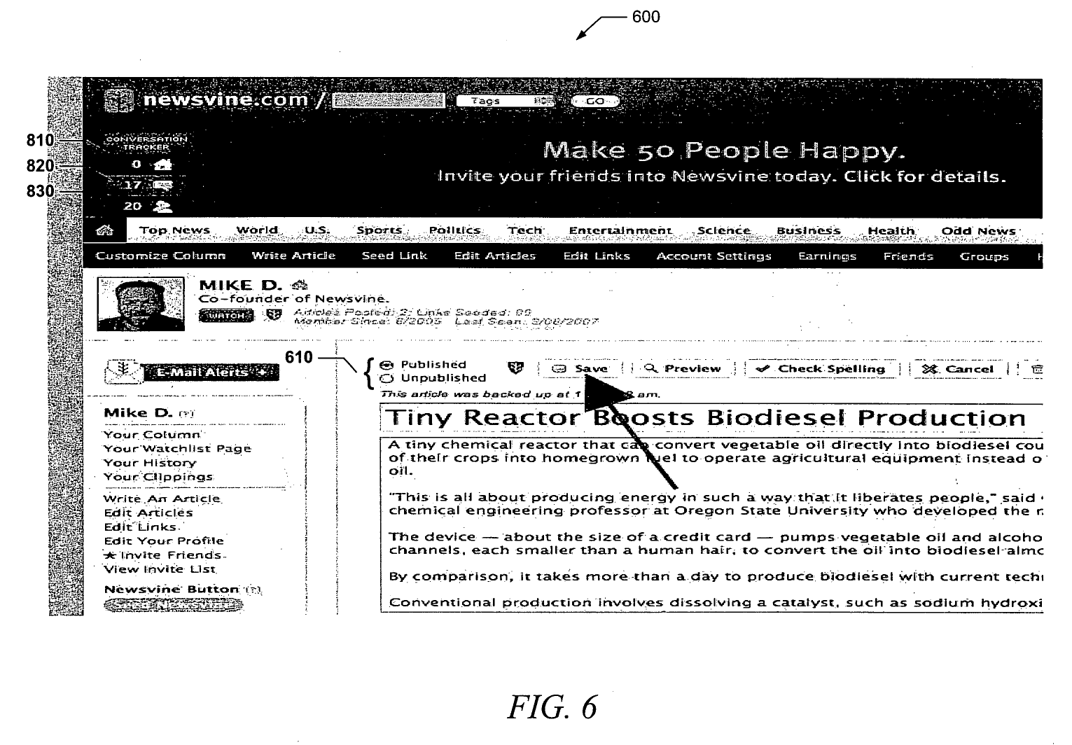

Once the actions have been stored in the tracking data store 170, the facility may use the data contained in the store to generate tracking statistics and provide the tracking statistics to web servers or other applications for presentation to users. The navigation and viewing of tracked content, and the presentation of tracking statistics, will now be described with reference to FIGS. 6-10. FIGS. 6-8 and 10 show screenshots of a user interface, such as an HTML browser, that are presented to a user.

FIG. 6 is a screenshot 600 of a user interface that allows a user to publish an article to a website. The user may write an article, specifying whether the article should be published or remain unpublished using radio control buttons 610, and save the article by selecting the “Save” button. In some embodiments, the user interface includes controls (not shown) to enable the user to establish a set of rules regarding actions that may be taken with respect to the published article. For example, a user may prefer to limit comments posted to a published article to those posted by friends of the user. As another example, a user may prefer to limit comments posted to an unpublished article to a selected group of users.

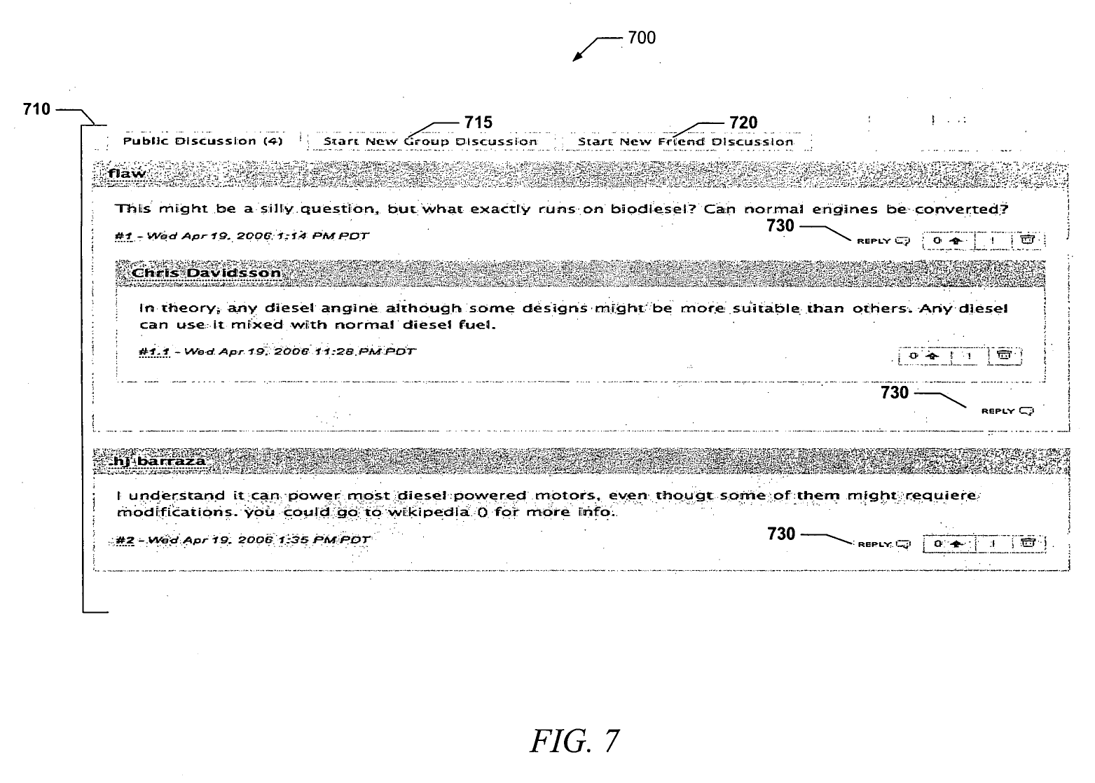

FIG. 7 is a screenshot 700 of a user interface that depicts a conversation associated with an item of content that is being tracked by the facility for one or more users. As described herein, when an item of content is published, it becomes publicly available to other users, and a public discussion 710 may develop around the content. The discussion may be limited by the set of rules established by the user that contributed the content. A user may reply to a comment by selecting a reply button 730. In some embodiments, the user interface includes a tab 715 that enables users to start a new group discussion pertaining to the content. Group discussions may be restricted to registered users and/or a specified group of users. Although restricted to certain users, group discussions may be publicly available. That is, users may view the discussion, but may not participate unless they are part of the group. In some embodiments, the user interface includes a tab 720 to enable users to start a new friend discussion around an item of content. Friend discussions may be restricted to friends of the user. These discussions may or may not be publicly available.

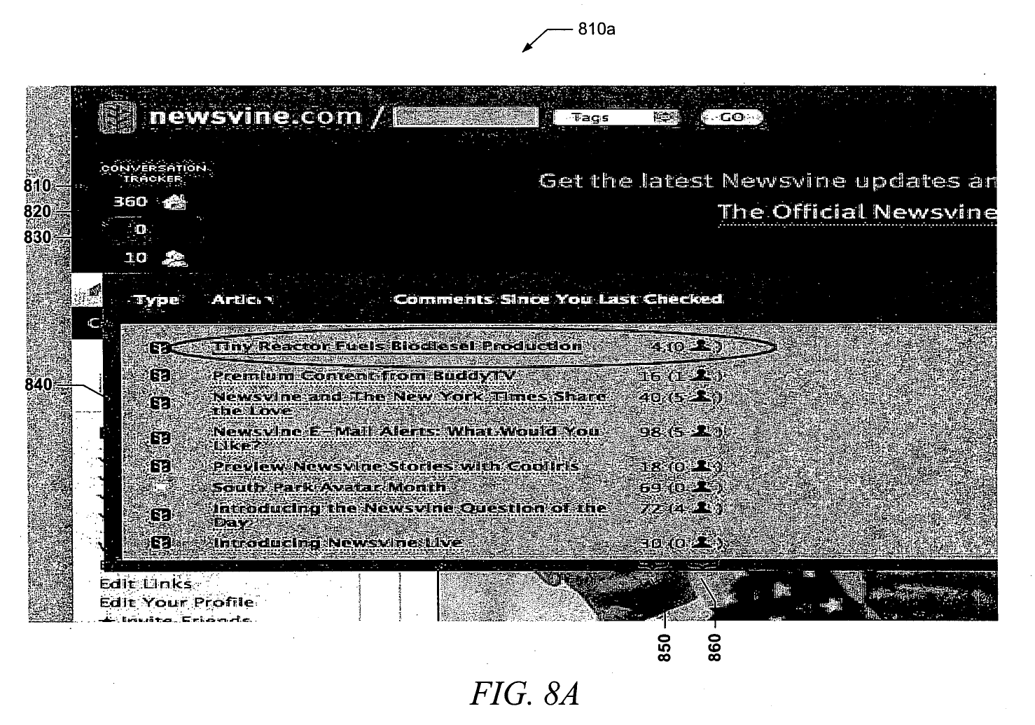

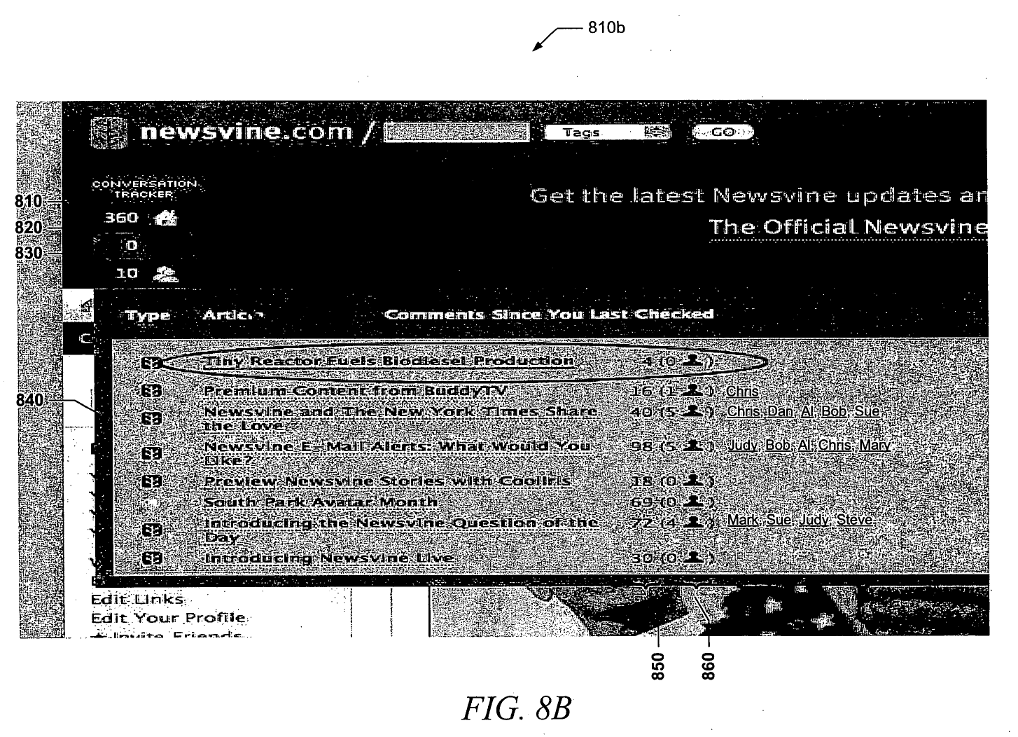

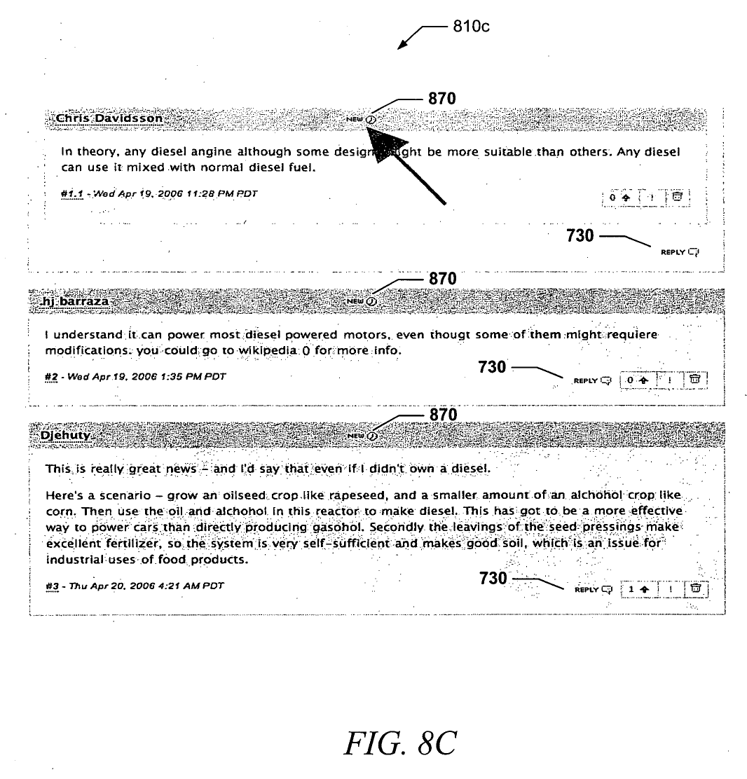

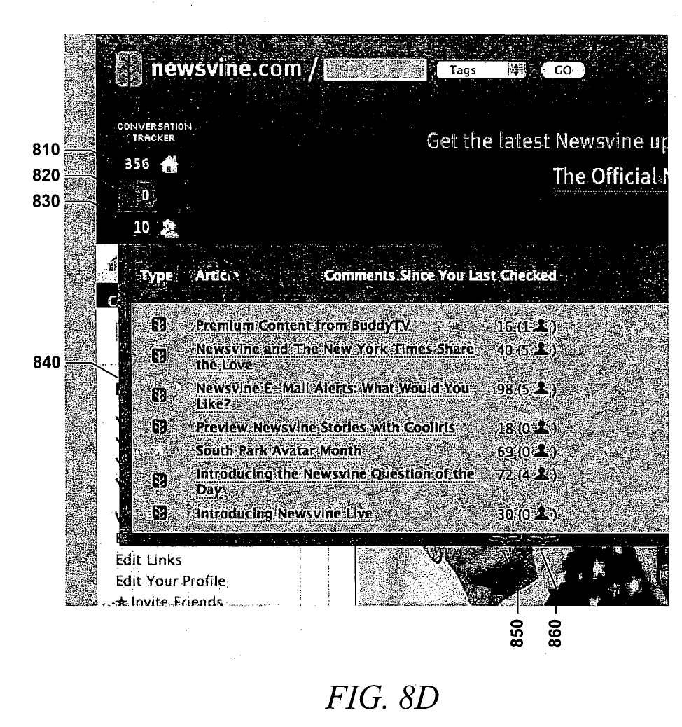

FIGS. 8A, 8B, 8C, and 8D are screenshots 800a, 800b, 800c, and 800d of a user interface that depicts a user's navigation to content that is being tracked by the facility. The interface contains various numerical indicators derived from the tracking data store that enable a user to quickly assess actions performed on tracked content and navigate to the actions or content. The numerical indicators that are indicate the number of actions performed on items of content that are being tracked for the user since the last time the user viewed or interacted with the tracked content. For example, a first numerical indicator 810 represents the number of new actions performed on items of content that are tracked by the facility for the user. A second numerical indicator 820 represents the number of new actions that have been performed on content after an action has been performed by the user (e.g., such as a comment posted on other content by the user). A third numerical indicator 830 represents the number of new actions performed by friends of the user. It will be appreciated that the number of numerical indicators that may be displayed may be a greater or lesser number than the five that are depicted. The facility operator or the user may be allowed to specify the number and type of numerical indicators that are displayed.

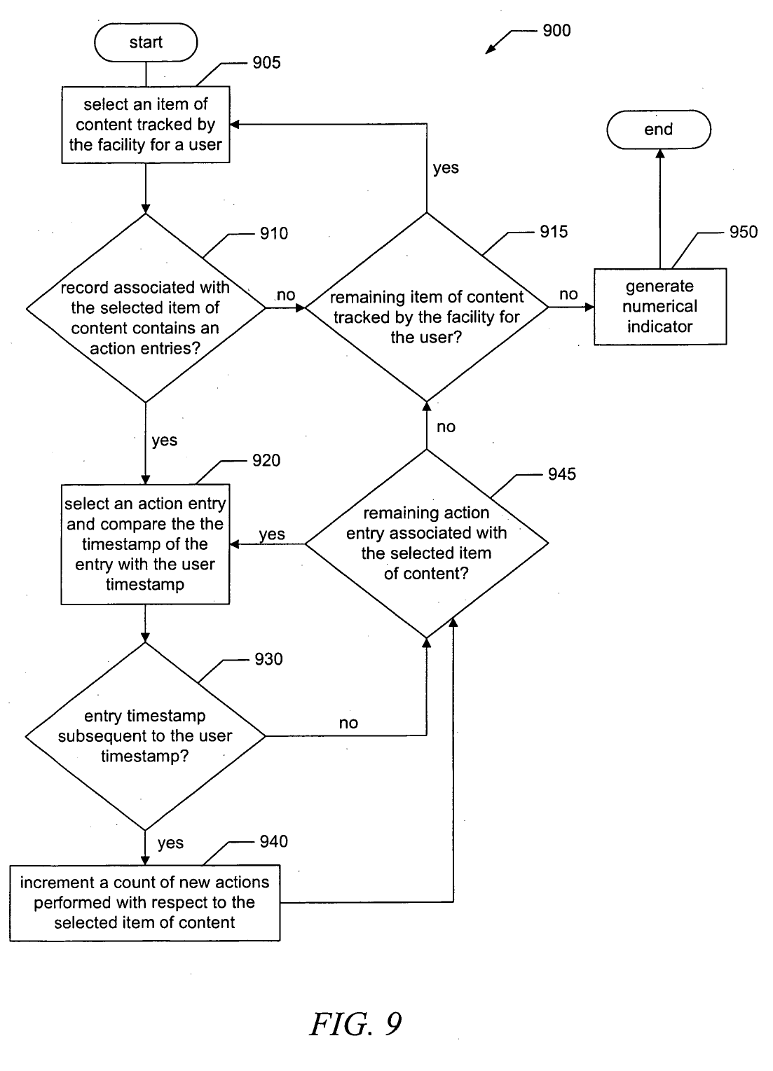

FIG. 9 is a flow chart of a process 900 performed by the facility to generate numerical indicator 810 (representing the number of new actions performed on items of content that are tracked by the facility for a user). The process 900 is executed to calculate numerical indicators for all items of content that are tracked by the facility for a user. At a block 905, the facility selects a tracked item of content associated with the user. At block 910, the facility determines whether the record 500 associated with the selected item of content contains one or more action entries 505. If the record does not contain any action entries, the facility continues to block 915. If the record associated with the selected item of content contains one or more action entries at block 910, processing continues to block 920. At block 920, the facility selects an action entry 505 and compares a user timestamp with a timestamp 520 of the selected action entry. The user timestamp represents the last time and/or date that the user viewed or interacted with the selected item of content. Typically, the user timestamp is maintained by the facility in the tracking data store. A “user view” may correspond to serving of a page that includes the selected item of content to the computer system operated by the user. A “user interaction” may correspond to an edit, response, or other action as is defined herein. At block 930, if timestamp 520 is subsequent to the user timestamp, the action occurred after the user's last view or interaction, and therefore is a new action for that user. In such a case, the tracking statistics are updated to reflect the new action. At a block 940, the facility increments a count of new actions performed with respect to the selected item of content. Processing then continues to block 945. If, however, the timestamp 520 is prior to the user timestamp at block 930, the action occurred prior to the user's view or interaction, and is therefore not new to the user. In such a case, the action can be omitted from the tracking statistics and the corresponding action entry may be deleted from the tracking data store. Processing then continues to block 945. At block 945, the facility determines whether there are any remaining action entries associated with the selected item of content. If there are remaining action entries, processing continues to block 920, otherwise processing continues to block 915. At block 915, the facility determines whether there are other tracked items of content associated with the user that have not been processed. If there are remaining tracked items of content that have not been processed, the facility continues to block 905 where the next tracked item of content associated with the user is selected. Otherwise, if there are no remaining tracked items of content, the facility continues to block 950. At block 950, the count for each item of tracked content is summed to generate numerical indicator 810. The process then ends.

It will be appreciated by those skilled in the art that the blocks shown in FIG. 9 may be appropriately altered to generate numerical indicators 820, 830, 850, and 860 as well as other numerical indicators. For example, to generate numerical indicator 830, the facility determines whether a user that performed an action having a timestamp 520 subsequent to the user timestamp has a defined relationship with the user (i.e., whether the user that performed the action is a friend, family member, colleague, etc. of the user). If a defined relationship exists, the facility increments another count (“friend count”) associated with the selected item of content. As another example, a numerical indicator could be generated that indicates the number of actions related to content on a subject for which the user has expressed an interest. To calculate such a numerical indicator, the facility would assess the subject field 530 of an action having a timestamp 520 subsequent to the user timestamp, and increment a count (“subject count”) if the subject field indicated that the action corresponded to the subject in which the user has expressed an interest.

When the user selects one of the numerical indicators, a corresponding tracking summary 840 is displayed to the user. The tracking summary 840 shown in screenshots 800a and 800b is a result of the user having selected numerical indicator 810. The tracking summary contains a list of tracked items of content for which actions have been detected, counted, and reflected by the corresponding numerical indicator. Each item of tracked content is listed individually within the tracking summary and is hyperlinked so that when the user selects an item of content, the item of content is displayed to the user. For each item of content, two additional numerical indicators are provided: a fourth numerical indicator 850 represents the number of new actions performed by others users with respect to the corresponding item of content, and a fifth numerical indicator 860 represents the number of new actions performed by friends of the user with respect to the corresponding item of content. In some embodiments, such as shown in screenshot 800b, the facility displays the names of the friends associated with the new actions. When the user selects a name of a friend, the first new action performed by the friend with respect to the item of content is displayed to the user (not shown).

It will be appreciated by those skilled in the art that an intermediate display may be presented to the user in addition to the numerical indicators and the tracking summary. For example, a user clicking on the third numerical indicator 830 (representing the friends of the user) may initially be presented with a list of those friends that have performed actions and the total number of actions performed by each friend. In such embodiments, if a user selects a friend, a list of items of content for which the selected friend has performed some type of action is displayed to the user.

FIG. 8C is a screenshot of a user interface depicting a users navigation to an item of content tracked by the facility. For example, when the user selects the first article from tracking summary 840, the first new action performed with respect to the item of content is displayed to the user as shown in screenshot 800c. The new action may be highlighted to the user by the use of a “new” icon 870 that is displayed in association with the action. When a user selects the “new” icon 870, the next new action is displayed to the user, and, if the end of a thread is reached, the next thread that contains a new performed action is displayed to the user. As a result, new performed actions may not always be displayed contiguously to the user. In some embodiments, actions performed by friends of the user are displayed in a manner that distinguishes the friends' actions from those that are performed by other users. For example, comments from friends may contain a special icon, highlighting, font, or other visual indicator (now shown) that the comment is associated with a friend. It will be appreciated that instead of a new icon 870, new actions may be distinguished through the use of highlighting, font, or other visual indicators.

When a new action is displayed to the user, the facility updates the tracking data store to reflect that the action is no longer new to the user. In some embodiments, the facility updates the tracking data store by updating the timestamp of the user with respect to that item of content. In some embodiments, the facility updates the tracking data store by deleting the action entry from the record associated with the item of content. The numerical indicators 810, 820, and 830, and the tracking summary 840 are also updated to reflect that the user has viewed the performed action. In some embodiments, the numerical indicators are updated in accordance with the process 900 reflected in FIG. 9 or similar processes. In some embodiments, the numerical indicators are updated by appropriately decrementing the numerical indicators. For example, as shown in screenshot 800d, after the user has viewed all of the new performed actions for the first item of content listed in tracking summary 840 of FIG. 8A, the facility updates tracking summary 840 to no longer display the first item of content. Numerical indicator 810 is also updated to reflect the reduced number of new actions performed on items of content tracked by the facility for the user.

In some embodiments, the facility assumes that the user has viewed a new performed action when a page containing the new performed action is served to the user's computer system. For example, if a page containing five new comments is displayed to the user on the user's computer system, the facility may assume that the user has viewed all five of the comments. In some embodiments, the facility may infer which actions have been viewed by the user based on actions taken by the user. For example, the facility may receive an indication of the scrolling position on a page that is displayed to the user and determine that new actions have been viewed by the user when the user scrolls to the position on the displayed page containing the new actions. In some embodiments, the facility requires an express indication that the user has viewed the new action, such as by receiving an indication that the user selected a “clear” control associated with that action. In some embodiments, the facility allows certain new actions to “expire” (i.e., no longer be considered new) if the actions were performed prior to a specified time without having been viewed by the user (e.g., a day, a week, a month has passed without the user viewing a comment posted on an item of content tracked by the facility).

In some embodiments, the facility updates the tracking data store when the user views a conversation without using the navigation tools of the user interface described herein (e.g., indicators 810, 820, 830, 840, 850, 860, etc.). That is, if a user happens to view an item of tracked content by searching for or otherwise navigating directly to that content, then new performed actions on that content may be cleared by the facility and the numerical indicators updated appropriately.

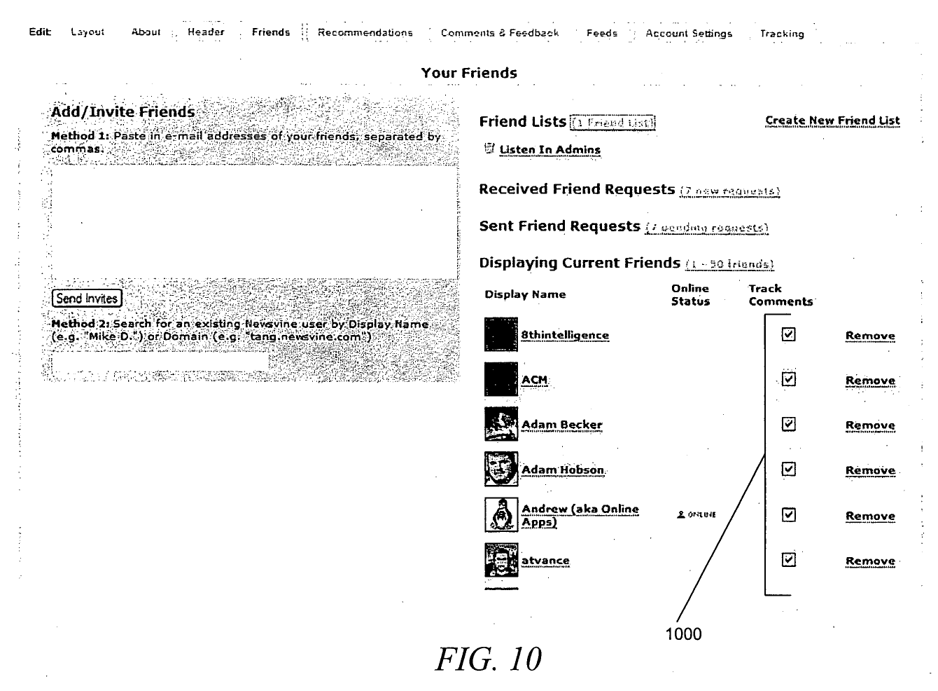

FIG. 10 is a screenshot of a user interface depicting a friends screen. In some embodiments, the facility enables users to create one or more friends lists. For example, a user may create one list of friends that includes the user's work colleagues and another list of friends that includes the user's family members. In some embodiments, the facility enables a user to track items of content posted by a friend regardless of whether the user has performed any action with respect to the content or selected the item of content for tracking. The user may indicate which friends to track by checking a box 1000 associated with each friend. This can result in the user's spontaneous discovery of new conversations or content based on the actions of the friends. In some embodiments, the facility enables the user to rank the importance (not shown) of content and/or actions performed by friends of the user. For example, the user may rank a family member that rarely contributes content as more important than a work colleague that frequently publishes content. A ranked list of friends that have contributed new content or performed actions on content may therefore be displayed to the user, so that the user can review the items of content that are likely to be the most important to the user.

It will be appreciated by those skilled in the art that the above-described facility may be straightforwardly adapted or extended in various ways. For example, it will be appreciated that the facility described herein may also be separated from a particular web site and offered as a service to other sites. That is, statistics for uniquely identified users may be gathered and distributed to third-party sites using appropriate embedded code on the third-party sites.

Those skilled in the art will also appreciate that the blocks shown in the flow charts of FIGS. 3, 4, and 9 may be altered in a variety of ways. For example, the order of blocks may be rearranged; substeps may be performed in parallel; shown blocks may be omitted; or other blocks may be included; etc.

While the foregoing description makes reference to particular embodiments, the scope of the invention is defined solely by the claims that follow and the elements recited therein.

We claim:

1. A method of tracking an item of content and displaying statistics related to actions taken with respect to the item of content, the method comprising:
receiving an indication of an item of content that is to be tracked for a user;
receiving and storing an indication of an action related to the tracked item of content each time that an action is taken with respect to the tracked item of content;
determining a time that a user last viewed the tracked item of content and any actions associated with the tracked item of content;
calculating a number of actions related to the tracked item of content that have occurred subsequent to the time that the user last viewed the tracked item of content and any actions associated with the tracked item of content;
displaying to the user the calculated number of actions related to the tracked item of content; and
displaying to the user a control related to the calculated number of actions related to the tracked item of content, wherein the operation of the control causes the user to be directed to the actions associated with the tracked item of content that have not yet been viewed by the user.

2. The method of claim 1, wherein the item of content to be tracked is expressly specified by the user.

3. The method of claim 1, wherein the item of content to be tracked is implicitly specified by the user.

4. The method of claim 3, wherein the item of content to be tracked is specified by a subject matter of the content.

5. The method of claim 1, wherein the item of content to be tracked is generated by the user.

6. The method of claim 1, wherein the item of content to be tracked is generated by a third-party.

7. The method of claim 1, wherein an action is selected from the group comprising a response, a comment, an edit, and a rating.

8. The method of claim 1, wherein the control is a hyperlink.

9. The method of claim 1 further comprising:
for at least some of the stored indications of actions taken with respect to the tracked item of content:
receiving and storing an identity of an individual that performed the action related to the tracked item of content; and
determining whether the stored identity of the individual has a relationship with the user;
calculating a number of actions related to the tracked item of content that are associated with individuals having a relationship with the user and which have occurred subsequent to the time that the user last viewed the tracked item of content and any actions associated with the tracked item of content;
displaying to the user the calculated number of actions related to the tracked item of content that were performed by individuals having a relationship with the user; and
displaying to the user a control related to the calculated number of actions related to the tracked item of content that were performed by individuals having a relationship with the user, wherein the operation of the control causes the user to be directed to the actions associated with the tracked item of content that were performed by individuals having a relationship with the user that have not yet been viewed by the user.

10. The method of claim 9, wherein the relationship is selected from a group comprising a friend, a family member, and a work colleague.

11. The method of claim 9, further comprising displaying to the user an indication of the individuals reflected by the calculated number of actions related to the tracked item of content.

12. The method of claim 11, further comprising displaying to the user a control related to the indicated individuals, wherein the operation of the control selects one of the indicated individuals and causes the user to be directed to the actions associated with the tracked item of content that were performed by the selected individual and that have not yet been viewed by the user.

13. A system for tracking an item of content and displaying statistics related to actions performed on the item of content, the system comprising:
a monitoring component configured to receive an indication of an item of content that is to be tracked for a user, receive an indication of an action related to the tracked item of content each time that an action is taken with respect to the tracked item of content, and store each received indication on an action;
a calculation component configured to determine a time that a user last interacted with the tracked item of content and any actions associated with the tracked item of content, and calculate a number of actions related to the tracked item of content that have occurred subsequent to the time that the user last viewed the tracked item of content and any actions associated with the tracked item of content; and
a display component configured to display to the user the calculated number of actions related to the tracked item of content and a control related to the calculated number of actions related to the tracked item of content, wherein the operation of the control causes the user to be directed to the actions associated with the tracked item of content that are new to the user.

14. The system of claim 13, wherein the item of content to be tracked is expressly specified by the user.

15. The system of claim 13, wherein the item of content to be tracked is implicitly specified by the user.

16. The system of claim 15, wherein the item of content to be tracked is specified by a subject matter of content.

17. The system of claim 13, wherein the item of content to be tracked is generated by the user.

18. The system of claim 13, wherein the item of content to be tracked is generated by a third-party.

19. The system of claim 13, wherein an action is selected from the group comprising a response, a comment, an edit, and a rating.

20. The system of claim 13, wherein the control is a hyperlink.

21. The system of claim 13, wherein:
the monitoring component is further configured to receive and store, for at least some of the stored indications of actions taken with respect to the tracked item of content, an identity of an individual that performed the action related to the tracked item of content;
the calculation component is further configured to determine whether each stored identity of an individual has a relationship with the user and to calculate a number of actions related to the tracked item of content that are associated with individuals having a relationship with the user and which have occurred subsequent to the time that the user last viewed the tracked item of content and any actions associated with the tracked item of content; and
the display component is further configured to display to the user the calculated number of actions related to the tracked item of content that were performed by individuals having a relationship with the user and a control related to the calculated number of actions related to the tracked item of content that were performed by individuals having a relationship with the user, wherein the operation of the control causes the user to be directed to the actions associated with the tracked item of content that were performed by individuals having a relationship with the user that have not yet been viewed by the user.

22. The system of claim 21, wherein the relationship is selected from a group comprising a friend, a family member, and a work colleague.

23. The system of claim 21, wherein the display component is further configured to display to the user an indication of the individuals reflected by the calculated number of actions related to the tracked item of content.

24. The system of claim 23, wherein the display component is further configured to display to the user a control related to the indicated individuals, wherein the operation of the control selects one of the indicated individuals and causes the user to be directed to the actions associated with the tracked item of content that were performed by the selected individual and that have not yet been viewed by the user.
